(19) United States
(12) Patent Application Publication
(10) Pub. No.: US 2024/0313572 A1
(43) Pub. Date: Sep. 19, 2024

(54) LOAD BANK CABLE TRANSPORTATION SYSTEM AND METHOD

(71) Applicant: M.C. Dean, Inc., Tysons, VA (US)

(72) Inventor: Ronald Rube WHITT, Boydton, VA (US)

(21) Appl. No.: 18/123,007

(22) Filed: Mar. 17, 2023

(51) Int. Cl. H02J 9/06; H02G 1/06

(52) U.S. Cl. CPC H02J 9/061; H02G 1/06

(57) ABSTRACT

Both a system and method for transporting and arranging a plurality of load bank cables to test an uninterruptible power supply (UPS) are provided. The system includes a plurality of cables configured to be electrically connected between an uninterruptible power supply and a load bank, and a cable conveying assembly including a plurality of pushcarts and configured to support the plurality of cables parallel to one another. Each pushcart is further configured to support the parallel cables in a spaced-apart relationship both horizontally and vertically. The cables are loaded onto the pushcarts such that portions of the plurality of cables disposed between the pushcarts form articulated joints in the cable conveying assembly. The UPS is tested while the cables are supported by the pushcarts.

### Field

This invention generally relates to a system and method for transporting a set of cables through a building, and is particularly concerned with the transporting and arranging of load bank cables used to test an uninterruptible power supply (UPS).

### Background

Some buildings such as data centers and hospitals require redundant sets of power sources to provide a reliable, uninterrupted flow of electrical power to digital processing equipment or life support machinery, respectively. The redundant power supply provided to such buildings is referred to as an uninterruptible power supply (UPS) and is usually comprised of a combination of batteries and on-site, diesel-powered electrical generators. In the event of a failure of the power grid that provides the primary source of power, the switchgear of the building is programmed to transition over to the UPS in a seamless fashion, thereby preventing loss of life in a hospital or a catastrophic loss of data in a data center.

Because of the criticality of the UPS, it must be periodically tested to ensure that it will function properly in the event of a grid power failure. Data centers are typically formed from anywhere between 5 to 25 standardized modules, each of which includes its own UPS. The UPS for each module may provide between 14 and 17 individual, three-phase 480V AC outlets, with each phase carrying a current of about 400 amps. The UPS is tested by a load bank which simulates the load that the banks of servers and other electrical equipment apply to the power source. During testing, the load bank (which is usually trailer-mounted) is wheeled toward a side of the data center close to the outlets of the UPS. The 480 V AC outlets of the UPS are connected to the load bank input terminals by means of a set of between 42 and 50 load bank cables. The UPS is then actuated and monitored to determine how it would operate in the event of an actual loss of power from the power grid.

Each of the load bank cables is about an inch in diameter to conduct 400 A for the three-to-five-hour duration of the UPS test and may be 50 feet or longer to span the distance between the 480 V AC outlets of the UPS and the input terminals of the load bank. Presently, the technicians conducting the test drag the cables through the hallways of the data center to the UPS outlets, arrange the cables in parallel on the floor in three-phase groupings to avoid the generation of eddy currents in the cables, connect the ends of the cables between the UPS and the load bank, and then proceed to test the UPS.

### SUMMARY OF THE INVENTION

While the present technique of transporting load bank cables and testing UPS's has proven to be useful, the applicant has observed a number of shortcomings in this technique. For example, pulling the 50 or so cables to the UPS, arranging them on the floor, and connecting them between the UPS and the load bank requires a crew of 4 to 5 men and takes about a day. Dragging of the load bank cables along the hallways of the data center can abrade away the cable insulating cover over time, ultimately compromising its ability to safely insulate the 480V AC, 400 A current from the technicians. Laying the cables on the floor during testing presents a tripping hazard to the technicians in the 4-foot width corridors of the data center, where the cables take up 3 feet or more of the corridor width even when closely arranged in parallel. It is also difficult to arrange the cables in parallel, three phase groupings without some cables overlapping others due to the limited space and the tendency of some cables to curl. Such overlapping interferes with the heat dissipation from the cables and induces eddy currents, which causes hot spots to occur in the cables. Since the cables heat up to temperatures as high as 90° C. from the 400 A current alone, the presence of such hot spots can soften and further compromise the insulating cover of the cables. Such overlapping also interferes with conducting a clear IR scan of the cables during testing to determine the integrity of the cable insulating covers.

Accordingly, there is a need for a system to transport load bank cables to the UPS of a data center that is quicker than previous techniques and that avoids damage to the insulating cover of the cables. There is also a need for a system and method to quickly arrange and maintain the cables in parallel, three-phase groupings during testing without using the floor of the data center, and without any overlapping occurring between cables. Ideally, such a system and method should facilitate IR scans to be conducted on the cables during the testing of the UPS so that worn cables can be detected quicker and with greater certainty. Finally, such a system and method should be compatible with building corridors having a width as small as four feet.

To these ends, the invention is a system and method for transporting and arranging a plurality of load bank cables to test a UPS that overcomes the shortcomings of the prior art. The system includes a set of load bank cables, and a cable conveying assembly including a plurality of pushcarts configured to support the set of cables parallel to one another. Each pushcart is further configured to support the parallel cables in a spaced-apart relationship both horizontally and vertically. The pushcarts are arranged in-tandem in a spaced-apart relationship, and the cables are loaded onto the pushcarts such that portions of the plurality of cables disposed between the pushcarts form articulated joints in the cable conveying assembly. The result is a flexible train of pushcarts.

Each pushcart is elongated and includes a plurality of steps that support the parallel cables in a spaced-apart relationship both horizontally and vertically. Preferably, the plurality of steps is arranged into a pair of opposing stair-like structures. Such a stair-like arrangement reduces the amount of width necessary for the pushcarts to support the 50 or so cables to 2 feet, which allows the pushcarts forming the cable conveying assembly to easily maneuver turns along the 4-foot-wide corridors of the data center or other building. Such a stair-like arrangement of the support steps also promotes dissipation of the heat generated by the cables during testing by spacing the cables apart both horizontally and vertically.

The cables are bundled together in three-phase groups including three cables each. The cable bundles preferably have a trefoil cross-section which reduces the width of the bundle while promoting good heat dissipation. Each of the steps of the pushcarts is preferably covered with a heat-insulating material to avoid damage from the 90° C. temperature that the load bank cables typically achieve during testing. The number and height of the steps is the same for each pushcart such that the cables are level when positioned on corresponding steps of the pushcarts.

In the method of the invention, the pushcarts are arranged in tandem in a spaced-apart relationship along their longitudinal axes, and the cables are bundled together in three-phase groups including three cables each. Next, each three-cable bundle is placed on corresponding steps of the push carts such that the portions of the three-cable bundles spanning the gaps between the pushcarts form articulated joints between the resulting train of pushcarts. Each three-cable bundle is bound to its supporting steps on the pushcarts by zip ties or the like. The load bank cables are then conveyed to a location between the outputs of the UPS and the inputs of the load bank by pushing the train of pushcarts. Each three-cable bundle is connected between a three-phase output of the UPS and a corresponding input of the load bank without removing the cable bundles from the train of pushcarts. The testing of the UPS is then conducted with the cable bundles positioned on the train of pushcarts thus eliminating the tripping and safety hazards associated with positioning the cables on the floor during testing. Additionally, the uniform horizontal and vertical spacing of the cables provided by the steps coupled with the lack of cable overlap promotes clear IR images when IR scans are made during testing.

### BRIEF DESCRIPTION OF THE SEVERAL DRAWINGS

FIG. 1 is a plan view of the load bank cable system, including the pushcarts forming the cable conveying assembly and the cable bundles that will be loaded on and carried by the conveying assembly;

FIG. 2A is a perspective view of one of the pushcarts forming the cable conveying assembly, illustrating the plurality of cable-supporting steps on the pushcarts arranged as a pair of opposing stair-like structures;

FIG. 2B is an end view of the pushcart illustrated in FIG. 2A;

FIG. 2C is a side view of the pushcart illustrated in FIG. 2A;

FIG. 2D is a partial perspective view of two cable bundles bound to different steps of the pushcart illustrated in FIG. 2A;

FIG. 3 illustrates the pushcart of FIG. 2A fully loaded with cable bundles with an IR scanner above it;

FIGS. 4A and 4B are plan views of a pair of pushcarts loaded with cable bundles such that the cables form an articulated joint in the gap between the pushcarts, and

FIG. 5 illustrates how the train of pushcarts supports the cable bundles during both the connecting of the cables between output terminals of the UPS and the input terminals of the load bank and during the testing of the UPS.

### DETAILED DESCRIPTION OF A PREFERRED EMBODIMENT

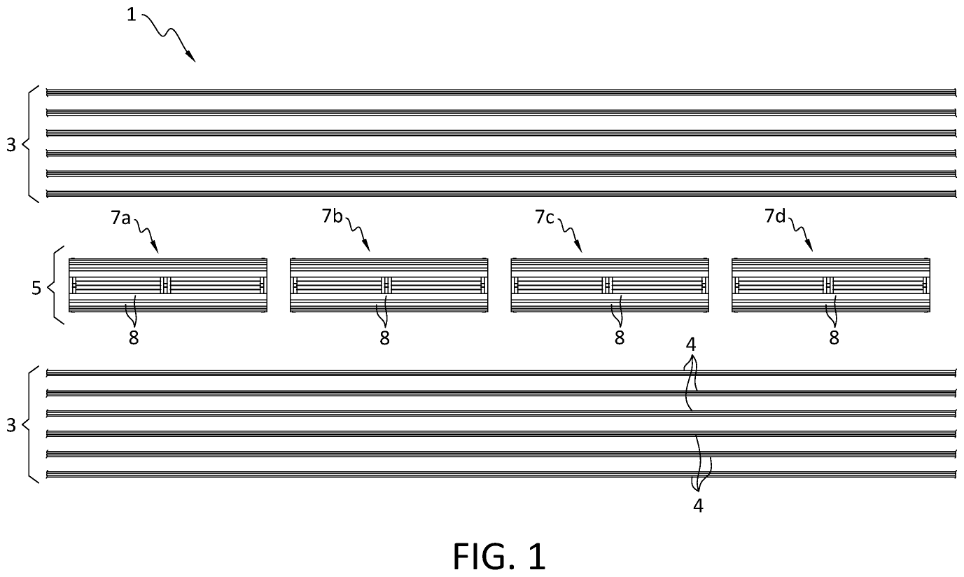

With reference to FIG. 1, the load bank cable transportation system 1 of the invention includes a set of load bank cables 3 that are arranged into three-cable bundles 4, and a cable conveying assembly 5 formed from a plurality of pushcarts 7a-7d. Each pushcart 7a-7d includes two sets of cable-supporting steps 8 on either side. Each of the load bank cables 3 has a stranded copper core rated for 400 amps and an insulating cover rated for 480V AC. In use, each of the three cables 3 forming a cable bundle 4 is connected to a different phase of the 480V AC, 400 A three-phase current generated by the UPS to avoid eddy currents that can cause hot spots on the cables 3. The load bank cables 3 typically come in 25 ft. and 50 ft. lengths which can be coupled together to form longer cables if necessary. In this example of the invention, the cables are 50 ft. in length and are moved by four pushcarts 7a-7d, each of which is 8 ft. in length. However, the cables may be longer or shorter (e.g., 25 ft., 75 ft., or 100 ft.) and the number of pushcarts may be commensurately lesser or greater depending on the distance between the UPS outlets and the load bank.

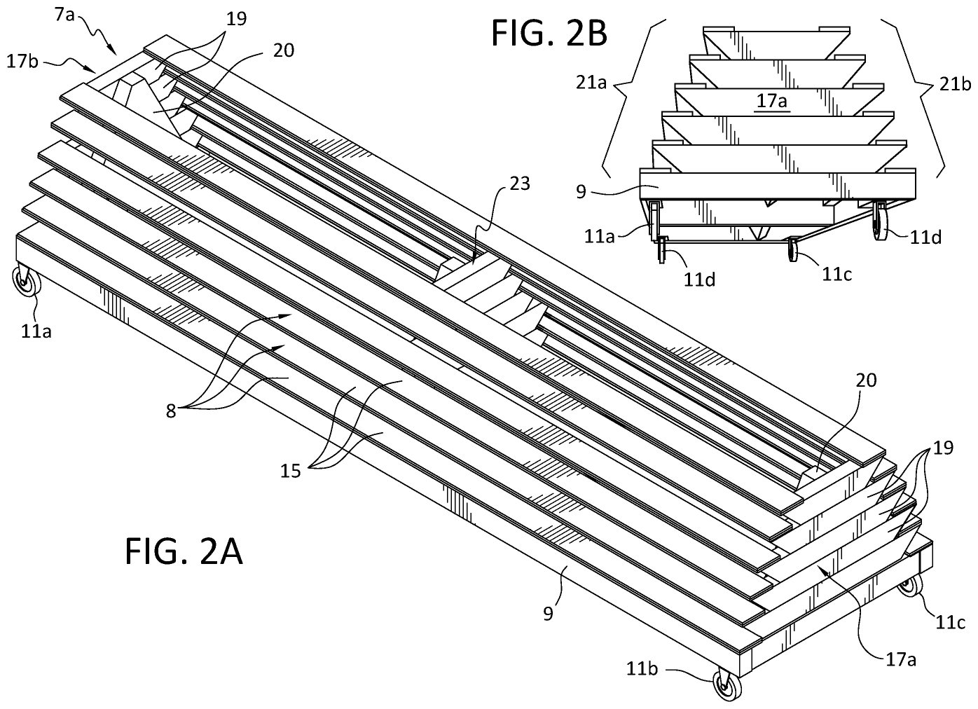

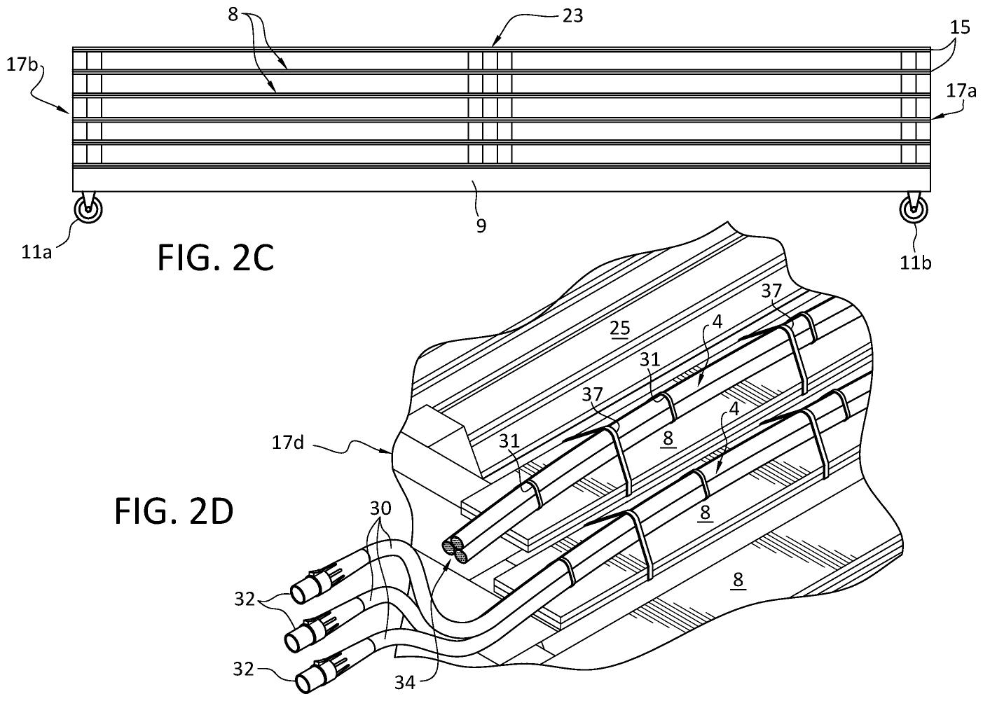

With reference to FIGS. 2A-2D, each of the pushcarts 7a-7d includes a rectangular frame 9 supported by four casters 11a-11d mounted in the corners thereof. Each of the steps 8 on either side of the pushcarts 7a-7d can support one, three-cable bundle 4 as shown in FIG. 2D. The frame 6 and steps 8 may be formed from wood for easy fabrication. The top surface of each step 8 includes a heat insulating layer 15 which may be formed from porcelain tiles to protect the steps from heat generated by the load bank cables 3 during a UPS testing procedure. As best seen in FIGS. 2A and 2B, each pushcart 7a-7d includes supports 17a and 17b at either end formed from a stack of trapezoidal members 19 that shorten over the height of the support. The trapezoidal members 19 are secured into the pattern shown by nailing or screwing them to a triangular backing member 20. Thus secured, the opposing ends of the trapezoidal members 19 form opposing staircase stringers 21a, 21b as shown in FIG. 2B that provide end supports for the steps 8. Finally, as is best seen in FIG. 2A, each pushcart 7a-7b includes a central support 23. The central support 23 is constructed in the same fashion as described with respect to the end supports 17a and 17b, and provides a pair of opposing staircase stringers that support the steps 8 at their mid-portions. The end result is that the cable-supporting steps 8 of each pushcart 7a-7d are uniformly spaced apart both horizontally and vertically and are arranged into a pair of opposing, stair-like structures.

The opposing stair-like configuration of the cable-supporting steps 8 is advantageous for at least three reasons. First, such a step configuration allows the pushcarts 7a-7d to support more cable bundles 4 within a smaller width without overlap than they would if they had a single, flat surface. This in turn allows the cable conveying assembly 5 to carry a full load of load bank cables (e.g., 42 cables) by means of a train of pushcarts 7a-7d having a width of only two feet, thereby giving the technicians two feet of room to handle the train of pushcarts in a 4-foot wide corridor of a data center or other building. Second, such a configuration facilitates the loading of the cable bundles 4 onto the steps from both sides of the pushcarts 7a-7d. Finally, during the testing of the UPS, the horizontal and vertical spacing apart of the cable bundles 4 provided by the steps 8 provides effective and uniform dissipation of the heat generated by the cables 3, which can attain a temperature of 90° C. as a result of the 400 A current that they conduct.

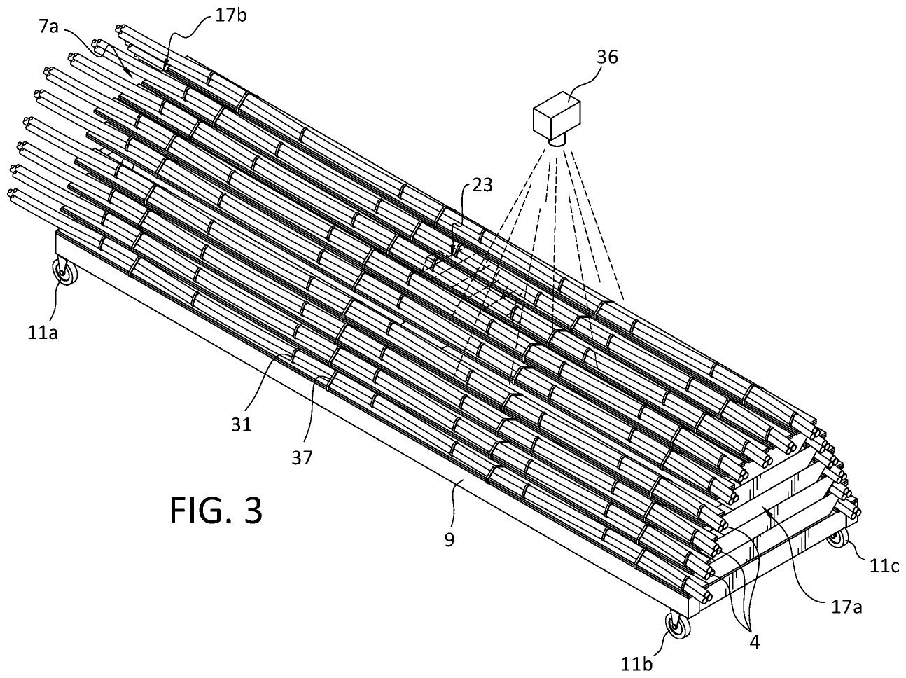

While each of the pushcarts 7a-7d may have a gap between the top two steps 8 as shown in FIG. 2A, a more preferred embodiment includes one or more additional cable support steps 25 disposed across this gap as is shown in FIG. 3. Such a variation increases the number of three-cable bundles 4 that the pushcarts 7a-7d can carry.

With reference now to FIGS. 2D and 3, each of the three-cable bundles 4 is formed from three individual cables 30 that have been bundled together by means of uniformly-spaced zip-ties 31. Each of the ends of the cables 30 terminate in electrical connectors 32 such as Cam-Lok® connectors. The three-cable bundles 4 have a trefoil cross-section 34 which minimizes the width of the bundles while allowing an IR scanner 36 elevated above the bundles 4 to scan all three cables 30 of each bundle 4 when one of the three sides of the triangularly-shaped bundle 4 lies flat onto one of the steps 8. The three-cable bundles are secured to their respective steps by additional zip-ties 37, thus insuring not only that one of the three sides of the triangularly-shaped bundle 4 lies flat onto one of the steps 8, but also that the bundles 4 will stay on their respective steps 8 during the movement of the pushcarts 7a-7d.

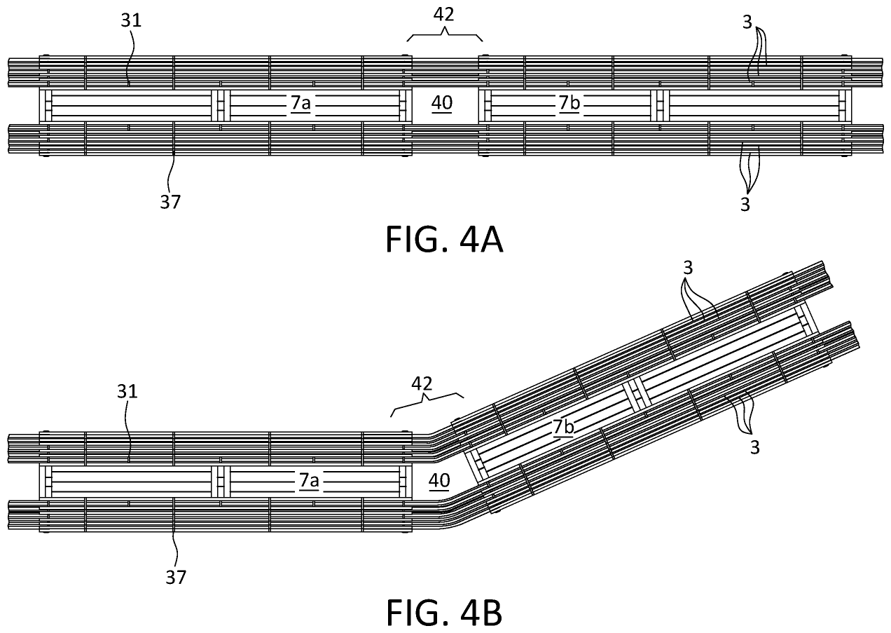

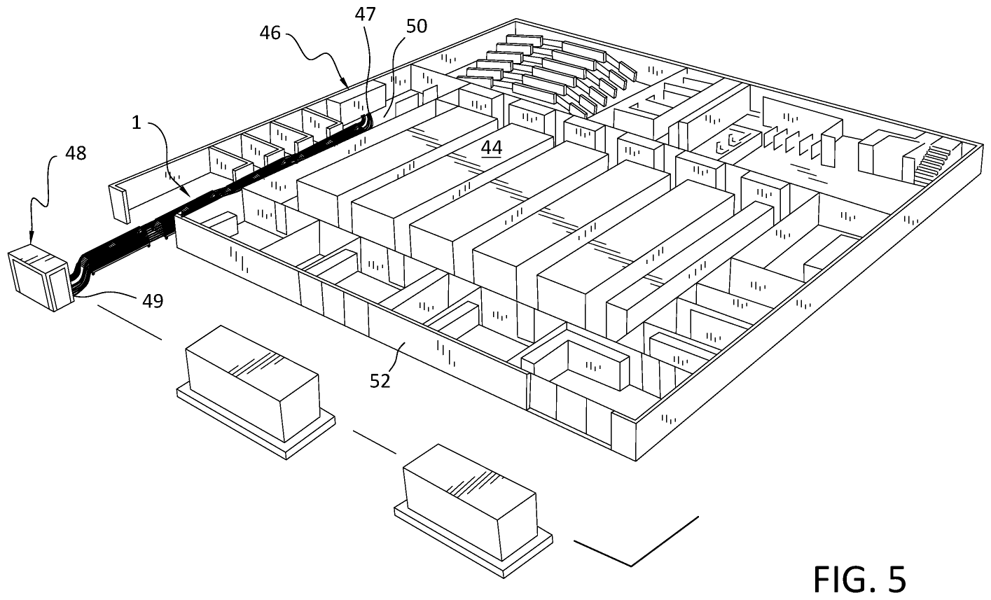

The first steps of the method of the invention will now be described with respect to FIG. 1. As indicated in FIG. 1, the set of load bank cables 3 are first joined into two sets of three-cable bundles 4 via zip-ties 31. The pushcarts 7a-7d forming the cable conveying assembly 5 are then moved between the two sets of cable bundles 4 and arranged colinearly in a spaced-apart relationship. Each bundle 4 is then loaded onto corresponding steps 8 of the pushcarts 7a-7d. For example, the first bundle 4 of one of the two sets is loaded onto the lowest step on the same side of each of the pushcarts 7a-7b, the second bundle 4 on the second step on the same side of each of the pushcarts 7a-7b, etc. As each bundle 4 is loaded, it is secured to its respective step via zip-ties 37. The loading continues on both sides of the pushcarts 7a-7d until all of the three-cable bundles 4 are loaded, at which point all the pushcarts will look the one illustrated in FIG. 3. As illustrated in FIGS. 4A and 4B, the resulting load bank cable transportation system 1 is essentially a train of pushcarts 7a-7d connected by articulated joints 42 formed from the portions of the cable bundles 4 traversing the spaces between the pushcarts. These articulated joints 42 provide the resulting transportation system 1 with the flexibility needed to maneuver turns in the corridors of the data center or other building where a load bank testing of an UPS is needed.

As illustrated in FIG. 5, the transportation system 1 is next moved into position in a data center 44 between the UPS 46 and a load bank 48 located outside the walls 52 of the data center 44. While not shown in the drawings, the load bank 48 is trailer-mounted so that it can easily be moved to a position outside the data center 44 close to the location of the UPS being tested. In preparation for the test, the cable connectors 32 on either end of the set of load bank cables 3 are connected to output connectors 47 of the UPS and input connectors 49 of the load bank 48. The UPS may have between 10 and 15 three-phase power sources, each of which includes three output connectors 47 for each of the three phases. One, three-cable bundle 4 is connected between the three output connectors of each three-phase power source and three input connectors 49 of the load bank 48 such that each of the three cables of the cable bundle 4 carries a different phase of a same power source. Such a connecting pattern avoids the creation of eddy currents that would otherwise occur when current of like phase is conducted between adjacent cables 3, which could degrade the insulating cover of the cables 3. During the test, the cable bundles 4 remain on their respective steps 8 of the pushcarts 7a-7d. Even though the 480V AC, 400 A current can heat the cables up to 90° C. during the typically four hours that such testing requires, the horizontal and vertical spacing of the cable bundles 4 due to the opposing staircase configuration of the steps 8 allows for effective and uniform heat dissipation. During the testing of the UPS, the integrity of the cables 3 may be examined via IR scanning as previously described with reference to FIG. 3.

At the end of the test, the cable bundles 4 may each be disconnected from the output connectors 47 of the UPS and the input connectors 49 of the load bank 48. Most data centers have more than one UPS, and the trailer-mounted load bank 48 can be moved to a position outside the data center 44 close to the location of another UPS, whereupon the load bank cable transportation system is moved along the data center corridors 50 between the other UPS and the load bank 48 and the method of the invention repeated.

What is claimed:

1. A load bank cable system for transporting and arranging a plurality of load bank cables used to test an uninterruptible power supply, comprising:
a plurality of cables configured to be electrically connected between an uninterruptible power supply and a load bank;
a cable conveying assembly including a plurality of pushcarts and configured to support the plurality of cables parallel to one another,
wherein each pushcart is further configured to support the parallel cables in a spaced-apart relationship both horizontally and vertically, and
wherein portions of the plurality of cables disposed between the pushcarts form articulated joints in the cable conveying assembly.

2. The load bank cable system defined in claim 1 wherein each pushcart includes a plurality of steps that support the parallel cables in a spaced-apart relationship both horizontally and vertically.

3. The load bank cable system defined in claim 1 wherein the cables are bundled together in three-phase groups including three cables each.

4. The load bank cable system defined in claim 2, wherein the cables are bundled together in groups including three cables each, and wherein each of the plurality of steps is configured to support one cable bundle.

5. The load bank cable system defined in claim 4, wherein the cable bundles have a trefoil cross-section.

6. The load bank cable system defined in claim 2, wherein each of the plurality of steps is covered with a heat insulating material.

7. The load bank cable system defined in claim 1, wherein the system is used to test an uninterruptible power supply in a building having access corridors through which the load bank cables are transported to the uninterruptible power supply, and wherein a width of the push parts is no more that half of a width of the access corridors.

8. The load bank cable system defined in claim 2, wherein the supporting steps of each of the pushcarts are arranged into a pair of opposing stair-like structures.

9. A load bank cable system that transports a plurality of load bank cables to an uninterruptible power supply in a building, and arranges the cables in a spaced-apart relationship during a load bank testing of the uninterruptible power supply, comprising:
a plurality of cables configured to be electrically connected between an uninterruptible power supply and a load bank;
a cable conveying assembly including a plurality of pushcarts arranged in-tandem and configured to support the plurality of cables parallel to one another,
wherein each pushcart includes a plurality of steps arranged into a pair of opposing stair-like structures, each step of which supports the parallel cables in a spaced-apart relationship both horizontally and vertically, and
wherein portions of the plurality of cables disposed between the in-tandem pushcarts form articulated joints in the cable conveying assembly.

10. The load bank cable system defined in claim 8 wherein the cables are bundled together in groups including three cables each, and wherein each of the plurality of steps is configured to support one cable bundle.

11. A method for transporting and arranging a plurality of load bank cables used to test an uninterruptible power inside a building supply by means of a cable conveying assembly including a plurality of pushcarts and configured to support the plurality of cables parallel to one another in a spaced-apart relationship both horizontally and vertically, comprising the steps of:
arranging the pushcarts in tandem in a spaced-apart relationship along their longitudinal axes;
loading the cables onto the cable conveying assembly in parallel relationship such that portions of the cables extend across the spaces between the pushcarts to form articulated joints between the pushcarts;
transporting the cables through the building to the uninterruptible power supply;
connecting the cables between an output of the uninterruptible power supply and an input of a load bank, and
testing the uninterruptible power supply while the cables are supported on the pushcarts.

12. The method for transporting and arranging a plurality of load bank cables defined in claim 11, further including the step of conducting an IR scan of the cables during testing to determine if any faults are present in an insulation covering of the cables.

13. The method for transporting and arranging a plurality of load bank cables defined in claim 11, wherein each pushcart includes a plurality of steps that support the parallel cables in a spaced-apart relationship both horizontally and vertically, and further including the step of bundling the cables together in groups of three and loading each cable bundle onto one of the plurality of steps.

14. The method for transporting and arranging a plurality of load bank cables defined in claim 13, wherein each of the three cables forming each bundle are configured to connect to a different phase of a three-phase power supply to avoid eddy-current heating during the testing of the uninterruptible power supply.

15. The method for transporting and arranging a plurality of load bank cables defined in claim 13, wherein the cables are bundled together such that each bundle has a trefoil cross-section.

16. The method for transporting and arranging a plurality of load bank cables defined in claim 13, further including the step of securing each cable bundle to its respective step.
